(19) United States
(12) Patent Application Publication
(10) Pub. No.: US 2017/0341313 A1
(43) Pub. Date: Nov. 30, 2017

(54) Process for the Production of SMC Hollow Components

(71) Applicant: Bayerische Motoren Werke Aktiengesellschaft, Muenchen (DE)

(72) Inventors: Thomas MIADOWITZ, Ergolding (DE); Markus REISS, Muenchen (DE)

(21) Appl. No.: 15/682,059

(22) Filed: Aug. 21, 2017

Related U.S. Application Data
(63) Continuation of application No. PCT/EP2016/061103, filed on May 18, 2016.

(30) Foreign Application Priority Data
May 28, 2015 (DE) 10 2015 209 762.5

(51) Int. Cl. B29C 70/18; B29C 70/30; B29C 70/54; B29C 70/46; B29L 22/00; B29D 22/00

(52) U.S. Cl. CPC B29C 70/18; B29C 70/543; B29C 70/462; B29C 70/30; B29D 22/00; B29L 2022/00

(57) ABSTRACT

A process for the production of fiber composite hollow SMC components is provided. In the process an SMC-suitable semi-finished fiber composite material is arranged over or around a wash-removable salt core system. The semi-finished fiber composite material and core system are arranged in an SMC mold, followed by molding of an SMC component incorporating the semi-finished fiber composite material and core system. The wash-removable salt may then be removed by washing to result in an SMC component containing a hollow region.

### CROSS REFERENCE TO RELATED APPLICATIONS

This application is a continuation of PCT International Application No. PCT/EP2016/061103, filed May 18, 2016, which claims priority under 35 U.S.C. §119 from German Patent Application No. 10 2015 209 762.5, filed May 28, 2015, the entire disclosures of which are herein expressly incorporated by reference.

### BACKGROUND AND SUMMARY OF THE INVENTION

The invention relates to a process for producing hollow fiber-composite components in the SMC process. SMC stands for sheet molding compound.

SMC is a long-established process for the production of fiber composite components. For reasons including the high pressure in the mold, however, it is presently as yet not possible to produce hollow SMC components.

As well as the production of hollow components in the high-pressure RTM process, a further option for the production of hollow components is afforded by pultrusion. That process enables continuous production of simple fiber-reinforced profiles.

A disadvantage of the prior-art processes is that the high-pressure RTM process requires core systems of high pressure resistance. For this purpose, for example, foam cores of high grammage are required, so that the injection pressure does not cause damage to the cores. Following production, the cores remain in the component, resulting in an unnecessarily increased component weight. This is undesirable in view of the objective of lightweight construction.

Blow mold cores can be removed again following component production, but are of only limited pressure resistance. The operating regime associated is very costly and complex.

The pultrusion process is limited in terms of the shapes that can be produced. Only very simple geometric structures with no change in cross section can be produced. Complex profiles with significant changes in contour cannot be manufactured.

It is an object of the invention, therefore, to provide a process by which hollow fiber-composite components can be manufactured in an SMC process in a manner which is both economic and suitable for large-scale automotive production.

The invention includes a process wherein a semifinished fiber composite suitable for SMC is arranged over or around a core system in an SMC mold and is molded by the SMC mold into a hollow construction, the core system having been formed from a wash-removable salt basis.

In large-scale automotive production, the conventional SMC operation is employed in particular in the area of paintable parts of the outer skin and can be employed as such for the invention as well. The operation is one of continuous compression molding, in which a preimpregnated, sheetlike semifinished product consisting of chopped short fibers and an epoxy/vinyl ester or unsaturated polyester matrix is inserted into a steel mold having a plunging edge which follows the contour of the component, and is compression-molded under the action of temperature and pressure. Heat energy acting on the heated mold halves reduces the viscosity of the matrix, with the semifinished fiber composite being converted into a fluid form. In this form, the material avoids the pressure which develops within the cavity as a result of the top and bottom molds moving toward one another, by undergoing an expansion movement, and fills the shape-conferring hollow chamber.

The salt-based core system allows the realization of hollow SMC profiles, because the salt has sufficient pressure resistance and heat resistance for the SMC mold. Either the core system is fastened in the SMC mold and the semifinished fiber composite is placed over it, or the core system is wound fully and then introduced into the SMC mold.

With a salt-based core system of the invention, moreover, it is possible to manufacture complex geometries with undercutting, thereby permitting flexible design of the components.

The simple, quick, and inexpensive facility for removal of the core by washing thereof in accordance with the invention following production of the component allows the potential for lightweight construction to be increased.

Because of the high stability of the salt core, the complexity of component production is reduced and the operational reliability is increased. Moreover, the costs are reduced and economic advantages are achieved.

In one embodiment of the process, the core system has been formed from at least one salt crystal produced in a core shooting operation. This salt crystal is produced in the core shooting operation under pressures of up to 800 bar. As a result, the pressure resistance of the salt core becomes very high and ensures that it can be used in the SMC mold. In an alternative version, the salt crystal is produced by drying of a salt lye.

Furthermore, in one embodiment of the invention, the semifinished fiber composite is folded or wound around the core system. The number of layers in this case is variably adaptable.

One variant embodiment of the invention is characterized in that the core system is formed from a plurality of individual cores. The plurality of individual cores here may be fixed in the SMC mold with spacing from one another, using leading mold parts, referred to as leaders/sliders, and may be covered by the semifinished fiber composite. By this means it is possible also to manufacture elongated components.

Because of the possibility for the core system to be completely wrapped or to be covered, the process of the invention is suitable for producing hollow fiber-composite components with a hollow design which is completely closed or else is open on one side.

In one development of the process of the invention, the core system has elevations and/or recesses in negative form, whose shapes are transferred to the semifinished fiber composite and are generated in positive form in the hollow fiber-composite component. This allows a high degree of freedom in design of the SMC components as complex hollow profiles. The components can be stiffened geometrically by thickened portions or changes in cross section or by beads or ribs. Additionally or alternatively, connection points may be introduced in the SMC production procedure itself, using inserts into the component, without a subsequent joining step. In the representation of nodal elements in particular, the monolithic node structure removes the need for a joining step in the form of adhesive bonding of two shells, and therefore removes the greatest weak point in the structure. The component produced can be removed as a complete whole from the SMC mold.

The process of the invention further includes the possibility that connection geometries and/or screw-attachment geometries are provided on the semifinished fiber composite and are co-molded on in the SMC mold. The number of operating steps for the production of the hollow SMC components is reduced as a result of operational integration. As a result, additional cost savings can be made.

Other advantageous developments of the invention are characterized in the dependent claims. The performance of the invention is not limited to the preferred performance examples indicated above. Instead, a number of variants can be conceived which make use of the solution shown, even in the case of fundamentally different kinds of embodiments. For example, there are various ways in which the core system can be fastened within the mold.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for producing hollow fiber-composite components, comprising the acts of:
arranging a semi-finished fiber composite at least one of over and around a core system formed from a wash-removable salt;
arranging the semi-finished fiber composite and the core system in an SMC mold; and
molding an SMC component in the SMC mold containing the semi-finished fiber composite and the core system.

2. The process as claimed in claim 1, further comprising the act of:
forming the wash-removable salt core system from at least one salt crystal in a core shooting operation.

3. The process as claimed in claim 1, further comprising the act of:
forming the wash-removable salt core system from by drying of a salt lye.

4. The process as claimed in claim 1, wherein
the semi-finished fiber composite is folded or wound at least sectionally around the core system.

5. The process as claimed in claim 1, wherein
the core system is formed from a plurality of individual cores.

6. The process as claimed in claim 5, wherein
the plurality of individual cores are fixed in the SMC mold with spacing from one another and are covered by the semi-finished fiber composite.

7. The process as claimed in claim 1, further comprising the act of:
removing the core system wash-removable salt from the molded SMC component using a wash, such that a hollow region remains in the SMC component where the core system wash-removable salt has been removed.

8. The process as claimed in claim 7, wherein
at least a portion of the hollow region is open on one side.

9. The process as claimed in claim 7, wherein
the core system has at least one of elevations and recesses in negative form,
the at least one of elevations and recesses are transferred in positive form to the semi-finished fiber SMC composite component.

10. The process as claimed in claim 1, further comprising the act of:
including at least one of connection geometries and screw-attachment geometries on the semi-finished fiber composite prior to the act of molding the SMC component.
